(19) United States
(12) Patent Application Publication
(10) Pub. No.: US 2002/0175893 A1
(43) Pub. Date: Nov. 28, 2002

(54) Multidimensional coordinate signal input apparatus

(76) Inventor: Steve Ore-Yang, Dist. Taipei (TW)

Correspondence Address: Edwards & Angell, LLP, 130 Water Street, Boston, MA, 02109-4280, US

(21) Appl. No.: 10/000,629

(22) Filed: Oct. 31, 2001

(30) Foreign Application Priority Data
Jan. 15, 2001 (TW) 90200739
Jul. 11, 2001 (CN) 01 2 31311.4

(51) Int. Cl. G09G 5/00

(52) U.S. Cl. 345/156

(57) ABSTRACT

There is disclosed a multidimensional coordinate signal input apparatus integrable into an input hardware interface for use in a data processing unit. The multidimensional signal input apparatus is operatively configured to provide multidimensional input signals to adjust a cursor address on a display screen of the data processing unit or control the scroll bar movement of an application program running on the data processing unit, and comprises a trackball module which is revolvable in response to an impetus caused by a user, at least two wheels, each of which has a side surface being in contact with the trackball module and revolves with the trackball module for detecting a movement of the trackball module along one axis of a multidimensional coordinate system and generating an input signal along the axis of the multidimensional coordinate system, and a microprocessor for receiving the input signals of the multidimensional coordinate system.

### FIELD OF THE INVENTION

The present invention is directed to a multidimensional coordinate signal input apparatus. More particularly, the present invention is directed to a multidimensional coordinate signal input apparatus which is integrable into an input hardware interface for use in a data processing unit.

### BACKGROUND OF THE INVENTION

At present, computer mouse device has become an indispensable peripheral input means to an ordinary computer user. The operation of the common computer mouse device basically utilizes a light-emitting diode (LED) to emits lights, and generates flickering optical signals by permitting the lights to pass through the photo grid which is provided with particular shadowing effect during the computer mouse device movement. The flickering optical signals are then converted by the photoelectric converting device into signals each having a phase difference, which are provided to be processed by the microprocessor of the computer mouse device to determine the moving direction of the computer mouse device.

In prior art, the photo grid mounted in a typical computer mouse device for providing shadowing effect to generate flickering optical signals is generally embodied in dual wheels. FIG. 1 depicts a prior art dual-wheel mouse device, in which one of the wheels (101,102) is responsible for providing the computer mouse device with the input signal along the X-axis, and the other wheel is responsible for providing the computer mouse device with the input signal along the Y-axis. With respect to the practical moving direction and the displacement of the prior dual-wheel mouse device, it is resolved by the mechanism of the computer mouse device and the firmware program embedded therein.

Nonetheless, the computer mouse device using a single wheel or dual wheels as the multidimensional coordinate signal input apparatus has some innate limitations, and is swore by the computer user for a long time. More particularly, the operation of the dual wheels will offend against the ergonomics. The only solution to fix the matter of operational inconvenience for the current computer mouse device is to select a trackball which is adapted for the human to manipulate the input data of the computer as the multidimensional coordinate signal input apparatus, instead of using dual wheels as the multidimensional coordinate signal input apparatus. Furthermore, only the X and Y coordinates of the mouse cursor address on the display screen require a high resolution, while the requirements imposed on the resolution of the other coordinates of the mouse cursor address on the display screen are set to be extremely low. Accordingly, the trackball is considerably suitable for the design of the multidimensional coordinate signal input apparatus for the computer mouse device.

In view of the foregoing advantages of taking the trackball as the multidimensional coordinate signal input apparatus, there tends to provide a multidimensional coordinate signal input apparatus which is integrated into an input means for use in a data processing unit.

### SUMMARY OF THE INVENTION

It is, therefore, an object of the present invention to provide a multidimensional coordinate signal input apparatus, which employs a trackball to provide multidimensional control signals to control a movement of a scroll bar of an application program running on a data processing unit.

To this end, a multidimensional coordinate signal input apparatus is designed to be integrable into an input hardware interface for use in a processing unit, wherein the multidimensional signal input apparatus is operatively configured to provide multidimensional control signals to control a movement of a scroll bar of an application program running on the data processing unit. In accordance with a preferred embodiment of the present invention, the multidimensional coordinate signal input apparatus comprises a trackball module which is revolvable in response to an impetus caused by a user, and at least two wheels, each of which has a side surface being in contact with the trackball module and revolves with the trackball module for detecting a movement of the trackball module along one axis of a multidimensional coordinate system and generating a multidimensional control signal along the axis of the multidimensional coordinate system. For the sake of clarifying the interrelation between the moving direction of the trackball module and the scroll bar, the firmware program embedded in the microprocessor of the multidimensional coordinate signal input apparatus is designed to coordinate the correspondence between the moving direction of the trackball module and the scrolling direction of the corresponding scroll bar of the application program.

In particular, the trackball module is formed from a marble or a polished refined ball by a resin injection molding process, and it can be implemented as a semi-optical mechanism or a pure optical mechanism. Moreover, the input hardware interface can be a computer mouse device, a keyboard, a digital camera or a trackball input means, and the data processing unit can be a personal computer or an image processing device.

Now the foregoing and other features and advantages of the present invention will be more clearly understood through the following descriptions with reference to the accompanying drawings, in which:

### BRIEF DESCRIPTION OF THE DRAWINGS

FIG. 1 is an exterior view of a prior dual-wheel mouse device;

FIG. 2 is an exploded view of the computer mouse device with a built-in multidimensional coordinate signal input apparatus in accordance with a preferred embodiment of the present invention;

FIG. 3(a) schematically illustrates a functional block diagram of the multidimensional scroll bar control apparatus according to a preferred embodiment of the present invention;

FIG. 3(b) is a schematic graph explicating a first type of interrelation between the moving direction of the trackball and the scroll bar of an application program running on a data processing unit;

FIG. 3(c) is a schematic graph explicating a second type of interrelation between the moving direction of the trackball and the scroll bar of an application program running on a data processing unit;

FIG. 4(a) is an outlined view of a computer mouse device with a trackball-implemented scroll bar control apparatus being integrated thereinto according to a first preferred embodiment of the present invention;

FIG. 4(b) is an outlined view of a computer keyboard with a trackball-implemented scroll bar control apparatus being integrated thereinto according to a second preferred embodiment of the present invention;

FIG. 4(c) is an outlined view of a digital camera with a trackball-implemented scroll bar control apparatus being integrated thereinto according to a third preferred embodiment of the present invention; and

FIG. 4(d) is an outlined view of a trackball input means 44 with built-in scroll bar control function.

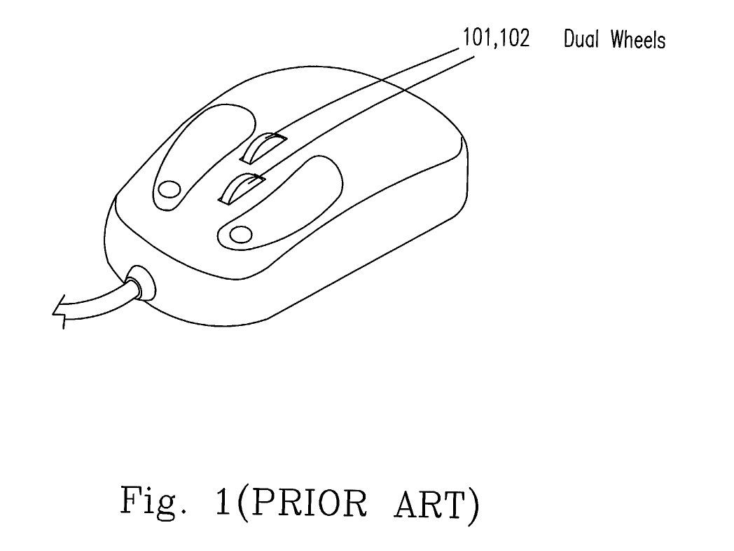

### DETAILED DESCRIPTION OF THE PREFERRED EMBODIMENT

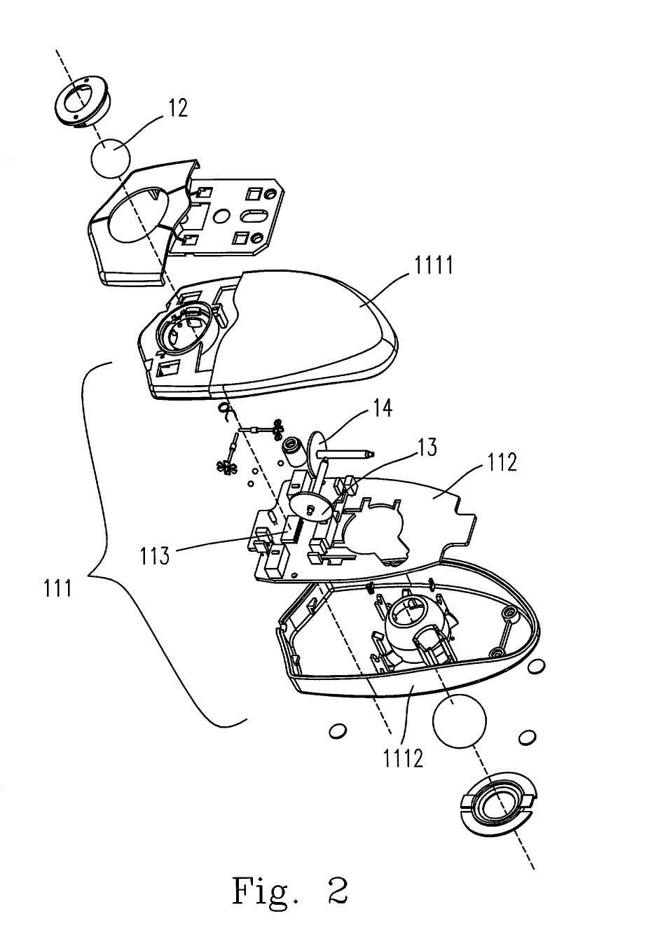

The multidimensional coordinate signal input apparatus integrable into an input hardware interface according to the present invention will now be illustrated in detail by the following descriptions. Referring now to FIG. 2, a first embodiment of the present invention is illustrated. The first embodiment of the present invention is to integrate the multidimensional coordinate signal input apparatus into a computer mouse device including a computer mouse body comprising a housing 111. The housing 111 further comprises a top cover 1111 and a base member 1112. The multidimensional coordinate signal input apparatus for providing the computer mouse device with input signals of a second multidimensional coordinate system according to the present embodiment is implemented by a trackball 12 and at least two wheels 13 and 14. Both of the wheels 13 and 14 has a side surface being in contact with the trackball 12. Specifically, the trackball 12 can be made up of a marble or a polished refined ball, and can be manufactured by a resin injection molding process. When the computer user rotates the trackball 12, the wheels 13 and 14 will rotate with the trackball 12, in which the wheel 13 is mated with the trackball 12 to detect the movement of the trackball 12 along a first axis of the second multidimensional coordinate system and provide the computer mouse device with input signals along the first axis, whereas the wheel 14 is mated with the trackball 12 to detect the movement of the trackball 12 along a second axis of the second multidimensional coordinate system and provide the computer mouse device with input signals along the second axis. The computer mouse device of FIG. 2 further includes a circuit board 112 being positioned over the base member 1112 for permitting a control device including circuitry for processing the multidimensional input signals generated by the wheels 13 and 14 to be mounted thereon. The aforementioned control device is directed to a microprocessor 113. The wheel 13 is employed to generate two input signals each having a phase difference, and the wheel 14 is also employed to generate two input signals each having a phase difference. The microprocessor 113 is used to receive and process the input signals generated by the wheels 13 and 14, and further the firmware program embedded in the microprocessor 113 is capable of determining the movement direction of the computer mouse device along each axes of the second multidimensional coordinate system.

As is well known in the art, the computer mouse device is dedicated to control the two-dimensional coordinate address of a cursor on a display screen. However, according to the present invention, the multidimensional coordinate signal input apparatus is allowable to serve as a multidimensional scroll bar control apparatus for supporting multifarious multidimensional coordinate control function for different application programs. Besides, in other embodiments, the control function for controlling the two-dimensional coordinate address of the scroll bars in an application program is further provided by the multidimensional coordinate signal input apparatus of the present invention, and it is inclined to give detailed descriptions afterwards.

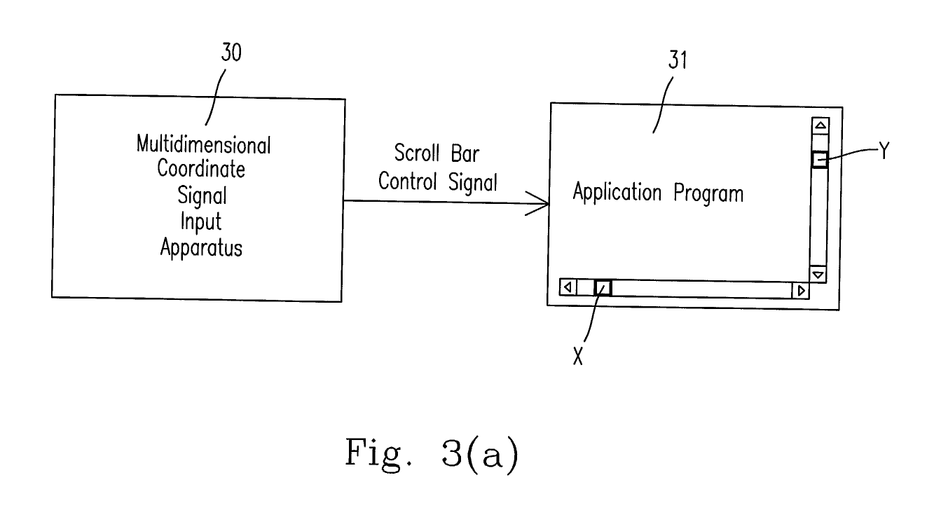

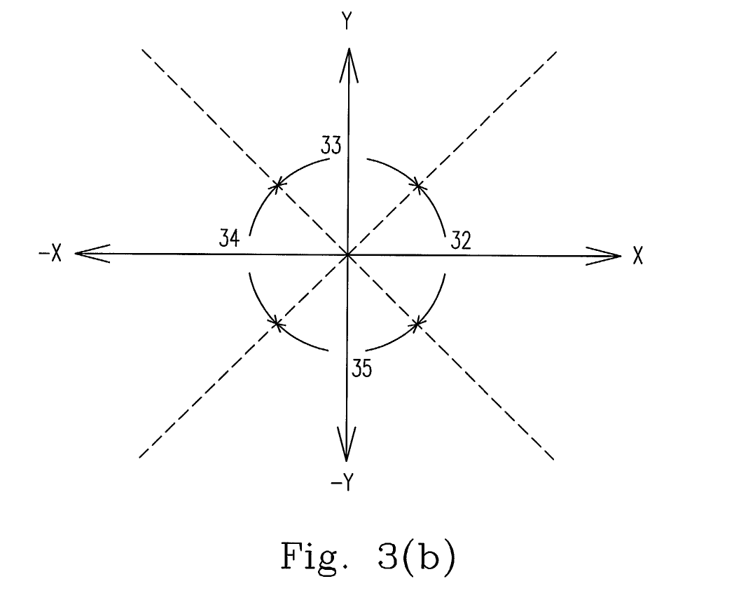

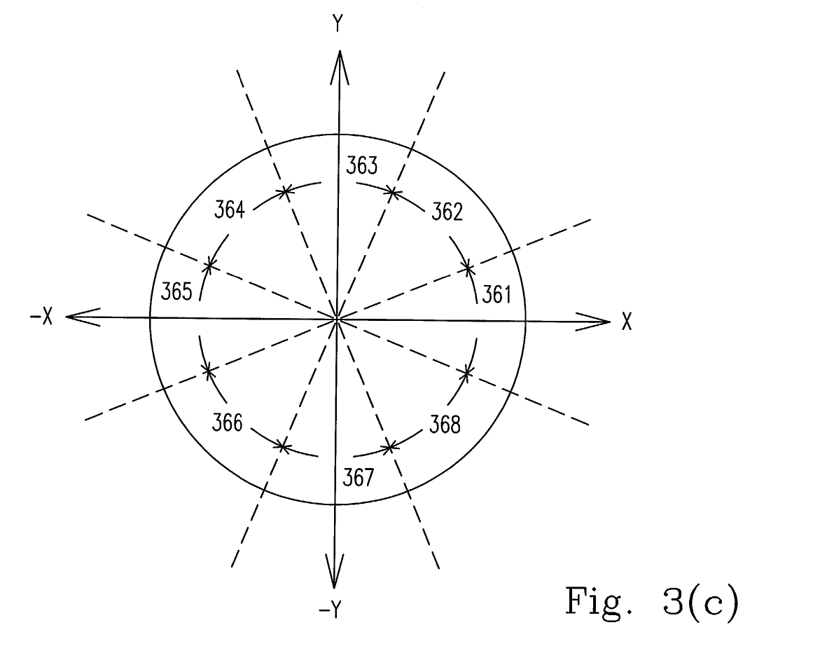

Referring to FIG. 3(a), a functional block diagram of the multidimensional scroll bar control apparatus according to a preferred embodiment of the present invention is shown. The multidimensional scroll bar control apparatus 30 which is put through by a trackball module is able to output a scroll bar control signal to an application program 31 running on a data processing unit having a display screen (such as a personal computer or an image processing device) for controlling the coordinate address (X-coordinate, Y-coordinate) of the scroll bars of the application program 31. The interrelation between the moving direction of the trackball and the scroll bars can be best understood by way of the chart of FIG. 3(b). It can be clearly seen from FIG. 3(b) that the two-dimensional coordinate plane is divided into zones 32, 33, 34 and 35. When the trackball is moving toward a certain zone, the scroll bar corresponding to the zone that the trackball is moving toward will be scrolled. For example, as the trackball is moving toward zone 32, the X-axis scroll bar of the application program will be scrolled toward right. The scroll movement of the other scroll bar can be deduced in an analogous manner. On the other hand, the interrelation between the moving direction of the trackball and the scroll bars can further be defined in accordance with the requirements on the control mechanism. As shown in FIG. 3(c), the two-dimensional coordinate plane is divided into zones 361, 362, 363, 364, 365, 366, 367 and 368. Therefore, in addition to the scroll bar movement control functions of the X-axis scroll bar and the Y-axis scroll bar of the application program along the up, down, left and right directions (which respectively corresponds to the trackball movement toward zones 362, 364, 366 and 368), the scroll bar control apparatus of the present invention can additionally support the scroll bar movement control functions along other directions (which respectively corresponds to the trackball movement toward zones 361, 363, 365 and 367) for future application program interface design.

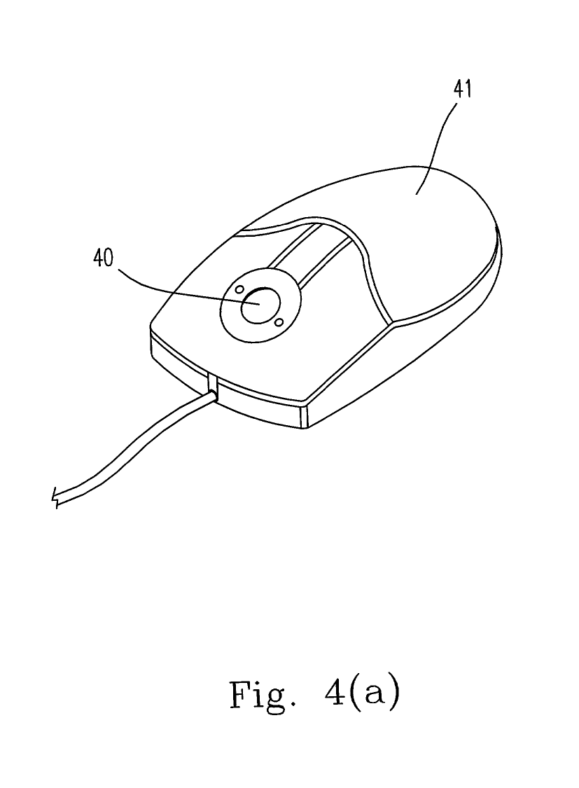

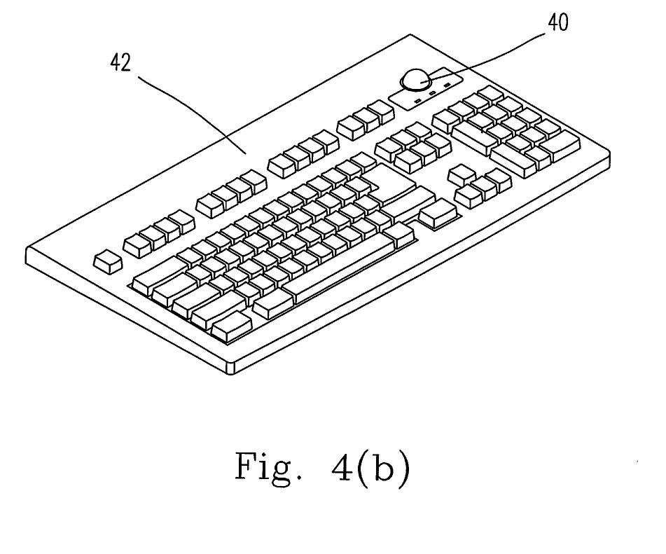

Turning to FIGS. 4(a) to 4(d), the preferred embodiments of the multidimensional coordinate signal input apparatus being integrated into various input means are shown. FIG. 4(a) shows an outlined view of a computer mouse device 41 with a trackball-implemented scroll bar control apparatus 40 being integrated thereinto. FIG. 4(b) shows an outlined view of a computer keyboard 42 with a trackball-implemented scroll bar control apparatus 40 being integrated thereinto. FIG. 4(c) shows an outlined view of a digital camera 43 with a trackball-implemented scroll bar control apparatus 40 being integrated thereinto, and FIG. 4(d) shows an outlined view of a trackball input means 44 with built-in scroll bar control function. In FIG. 4(d), the user only needs to press a function key 45 to switch control signals that is used to adjust the cursor location on the display screen into the control signals for controlling the scroll bar movement of an application program. In a similar way, the trackball-implemented scroll bar control apparatus as shown in FIGS. 4(a) to 4(c) can be designed to output the control signals for adjusting the cursor location or controlling the scroll bar movement. Certainly, the transmission between the input means with built-in multidimensional coordinate signal input apparatus and the data processing unit can be selected as in a wired form or in a wireless form as required.

It should be noted that though the trackball-implemented scroll bar control apparatus of the present invention can be made of a semi-optical mechanism as shown in FIG. 2. On the other hand, it can be made of a pure optical mechanism as well.

The present invention substantially provides a multidimensional coordinate signal input apparatus integrable into an input means for adjusting the cursor location or controlling the scroll bar movement of an application program. Comparing to the prior dual-wheel-implemented multidimensional coordinate signal input apparatus, the trackball-implemented multidimensional coordinate signal input apparatus of the present invention is more conformable to the user's requirements and additionally supports the control function of scroll bar movement of an application program. By way of combining the functions of cursor address adjustment and scroll bar movement control into an input hardware interface and further integrating the input interface into an input means, a convenient and ingenious manipulative interface for controlling the cursor movement or scroll bar rolling has become feasible.

Although the present invention has been described and illustrated in detail, it is to be clearly understood that the same is by the way of illustration and example only and is not to be taken by way of limitation, the spirit and scope of the present invention being limited only by the terms of the appended claims.

What is claim is:

1. A multidimensional coordinate signal input apparatus integrable into an input hardware interface for use in a data processing unit, said multidimensional signal input apparatus is operatively configured to provide a multidimensional control signal to control a movement of a scroll bar of an application program running on said data processing unit, said multidimensional coordinate signal input apparatus comprising:
a trackball module which is revolvable in response to an impetus caused by a user; and
at least two wheels, each of which has a side surface being in contact with said trackball module and revolves with said trackball module for detecting a movement of said trackball module along one axis of a multidimensional coordinate system and generating said multidimensional control signal along said axis of said multidimensional coordinate system.

2. The apparatus as defined in claim 1 wherein said trackball module is formed from a marble.

3. The apparatus as defined in claim 1 wherein said trackball module is formed from a polished refined ball.

4. The apparatus as defined in claim 1 wherein said trackball module is formed by a resin injection molding process.

5. The apparatus as defined in claim 1 wherein said trackball module is a semi-optical mechanism.

6. The apparatus as defined in claim 1 wherein said trackball module is a pure optical mechanism.

7. The apparatus as defined in claim 11 wherein said input hardware interface is one selected from a group of computer mouse device, a keyboard, a digital camera and a trackball input means.

8. The apparatus as defined in claim 1 wherein said data processing unit is a personal computer.

9. The apparatus as defined in claim 1 wherein said data processing unit is an image processing device.

10. The apparatus as defined in claim 1 further comprising a microprocessor for receiving said multidimensional control signal of said multidimensional coordinate system.
